(19) United States
(12) Patent Application Publication
(10) Pub. No.: US 2021/0073332 A1
(43) Pub. Date: Mar. 11, 2021

(54) AUTOMATIC LANGUAGE COACHING

(71) Applicant: Geigsen, LLC, Astoria, NY (US)

(72) Inventors: Christopher Creel, Atlanta, GA (US); Bharath Kumar Reddy Lingannagari, Atlanta, GA (US)

(21) Appl. No.: 16/562,902

(22) Filed: Sep. 6, 2019

(51) Int. Cl. G06F 17/27; H04L 12/58

(52) U.S. Cl. CPC G06F 17/2785; H04L 51/04

(57) ABSTRACT

Embodiments of the invention relate to automatic language coaching methods, systems, and products. The automatic language coaching methods, systems and products provide immediate, customized, and specific feedback to a sender of electronic communications to coach the sender to use effective language in written communications.

### BACKGROUND

Written communication suffers from a number of deficiencies compared to in-person communication. For example, visual cues and vocal inflections are absent in written communication. According to some experts, at least eighty percent of communication is non-verbal, or unrelated to the words that are spoken. The meaning, intent, or motivation of a message can be confused or altogether lost. Thus, written communication is particularly susceptible to misinterpretation.

### SUMMARY

Embodiments of the invention relate to automatic language coaching methods, systems, and products.

In an embodiment, a method of automatically coaching language used in electronic communications is disclosed. The method includes receiving natural language inputs for an electronic message entered into an electronic communication portal. The method includes analyzing the natural language inputs for compliance with a plurality of discrete criteria associated with effective communication. The method includes outputting one or more analyses corresponding to the plurality of discrete criteria to a dialogue engine. The method includes retrieving dialogue corresponding to the one or more analyses from the dialogue engine. The method includes publishing the dialogue corresponding to the one or more analyses to the communication portal before allowing the natural language inputs to be sent in the electronic message.

In an embodiment, a computer program product for automatically coaching interpersonal communication is disclosed. The computer program product includes a non-transitory memory storage medium storing computer readable and executable instructions. The instructions include instructions for receiving natural language inputs for an electronic message entered into an electronic communication portal. The instructions include instructions for analyzing the natural language inputs for compliance with one or more discrete criteria associated with effective communication. The instructions include instructions for outputting one or more analysis corresponding to the one or more discrete criteria to a dialogue engine. The instructions include instructions for retrieving dialogue corresponding to the one or more analyses from the dialogue engine. The instructions include instructions for publishing the dialogue corresponding to the one or more analyses to the communication portal before allowing the natural language inputs to be sent in the electronic message.

In an embodiment, a computing device for automatically coaching interpersonal communication is disclosed. The computing device includes a non-transitory memory storage medium storing machine readable and executable instructions. The instructions include instructions for receiving natural language inputs for an electronic message entered into an electronic communication portal. The instructions include instructions for analyzing the natural language inputs for compliance with one or more discrete criteria associated with effective communication. The instructions include instructions for outputting one or more analyses corresponding to the one or more discrete criteria to a dialogue engine. The instructions include instructions for retrieving dialogue corresponding to the one or more analyses from the dialogue engine. The instructions include instructions for publishing the dialogue corresponding to the one or more analyses to the communication portal before allowing the natural language inputs to be sent in the electronic message. The computing device includes a processor configured to access and execute the machine readable and executable instructions.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIG. 1 is a block diagram of an algorithm for automatically coaching a user's language used in electronic communications, according to an embodiment.

FIG. 2 is a block diagram of an algorithm for automatically coaching a user's language used in electronic communications, according to an embodiment.

FIG. 3 is a block diagram of a system for automatically coaching language used in electronic communications, according to an embodiment.

FIG. 4 is a flow diagram of a method of automatically coaching language used in electronic communications, according to an embodiment.

FIG. 5 is a schematic of a controller for executing any of the example methods disclosed herein, according to an embodiment.

FIG. 6 is a block diagram illustrating an example computer program product that is arranged to store instructions for automatically coaching language used in electronic communications as disclosed herein.

### DETAILED DESCRIPTION

Embodiments of the invention relate to automatic language coaching in electronic communications. The methods, systems, and products disclosed herein provide immediate, customized language coaching to promote effective communication. The methods, systems, and products disclosed herein analyze natural language, electronically submitted by a user, for compliance with discrete criteria associated with effective communication, retrieve dialogue corresponding to any detected deficiencies in the natural language, and publish the dialogue to the user to invite the user to correct the deficiencies, all before the user sends the electronic message.

Written communications can be misinterpreted with unintended consequences. For example, users will often use humor or irony in written communications believing that the written language will be received in the same manner as verbal and/or in-person communication. Written language has dramatically less information that in-person verbal communication so it has a greater risk of misinterpretation or degraded effect.

Disclosed herein are methods, systems, and products for teaching expertise to novices through rapid iterations of trial and error in the moment a mistake occurs (e.g., language having deficiencies is input into a communication platform) so that the distance between the error and the lesson is short. The immediacy of the coaching provides an effective teaching tool to train the user to use language associated with effective communication using perceptual learning.

In embodiments, the methods, systems, and products disclosed herein may be implemented in software format, such as chat bots or e-mail interfaces, operating inside of collaboration platforms or technologies (e.g., chat software, messaging software, web-based e-mail interface, etc.) to leverage perceptual learning to teach users how to communicate effectively in written communications, without explicit instructions. The software operates inside of the collaboration platform with immediate exposure to all users. Users can present language meant to be shared with other users, the software immediately analyzes the provided text, and then tells the user if the text will have the maximum positive impact on the recipient. With each correction, the software leverages perceptual learning to teach users how to be more effective in their written communications when collaborating with one another. In this way, the methods, systems, and products disclosed herein can be used to modulate the communications between all users of the collaboration platform.

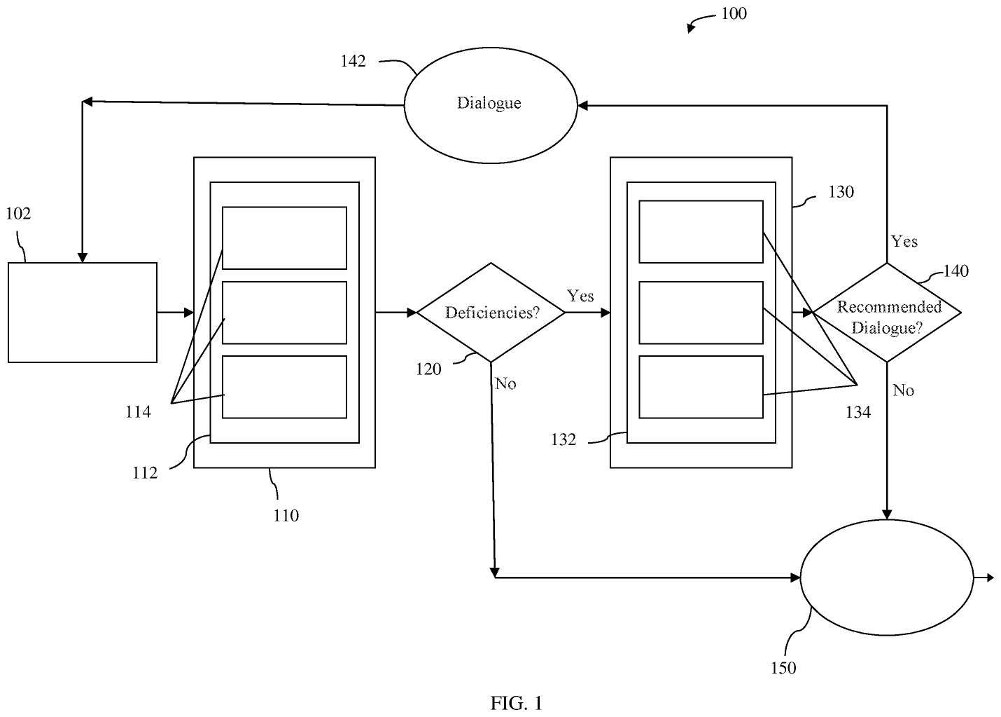

FIG. 1 is a block diagram of an algorithm 100 for automatically coaching a user's language used in electronic communications, according to an embodiment. The algorithm 100 describes a process for automatically providing customized, specific, immediate feedback for written communication provided as a natural language input. The algorithm 100 includes a natural language input 102, which is analyzed for deficiencies based on a plurality of criteria at block 110. Based on determination that there are or are not deficiencies in the natural language at block 120, the algorithm 100 fetches dialogue corresponding to the identified deficiencies at block 130 or provides a message that the electronic communication is ready to output to a receiver at block 150. At block 130, the dialogue corresponding to the identified deficiencies in natural language format is output. Based on dialogue corresponding to the identified deficiencies in the natural language at block 140, the algorithm 100 outputs the recommended dialogue to the natural language input 102 or provides no message to the user at block 150.

The natural language input 102 may be an electronic input of a written message in a communication platform or technology such as messaging program, an e-mail program, a chat bot, or any other electronic communication platform that receives and transmits natural language communication between users. The natural language input 102 may be provided in an e-mail, message field, chat window, or the like. The natural language input may be as little as a word or number or may be one or more phrases, sentences, or paragraphs. The natural language input 102 may be received by the communications platform and displayed in a user interface.

The natural language input 102 is analyzed to determine if there are any deficiencies in the natural language. For example, at block 110 the natural language may be searched for specific words, terms, phrases, sentences, syntax, sentiment, or other elements at block 110. The natural language may be broken down into sentences, phrases, and words to analyze the sentences, phrases, and words against a plurality of discrete criteria. The discrete criteria may include language that is positive, actionable, subjective, devoid of curt tone, devoid of irony, devoid of sarcasm, devoid of negativity, or the like. The discrete criteria may include sentiment. Further discrete criteria may be utilized depending upon the context of the communication. The discrete criteria may be stored in reference libraries or databases of words, phrases, syntax structure(s), sentences, sentence structure(s), grammar rules, etiquette rules, or other data corresponding to each specific discrete criteria. Through consultation with language and psychology experts, the inventors have identified at least some of the criteria of effective communication. For example, written communications that are positive, actionable, and subjective are effective to produce the desired objective of the communication more often than written communications that are not positive, actionable, and subjective.

Deficiencies in the natural language may include words, phrases, sentences, sentiment, or other portions of communication that are not associated with specific discrete criteria such as language that is positive, actionable, subjective, or reflecting a specific sentiment. For example, the deficiency related to at least one of the plurality of discrete criteria may include an absence of natural language addressing at least one of the plurality of discrete criteria, such as a lack of words or phrases known to be positive. Deficiencies in the natural language may include words, phrases, sentences, sentiment, or other portions of communication that are associated with specific discrete criteria such as language that is curt, containing irony, containing sarcasm, negative, or indicates a sentiment in opposition to a specific sentiment. For example, the deficiency related to at least one of the plurality of discrete criteria may include a presence of natural language addressing at least one of the plurality of discrete criteria, such as the presence words or phrases known to be curt.

In an analysis module 112 within block 110, each discrete criteria may have one or more corresponding separate analysis 114. Each analysis 114 may examine only one specific discrete criteria or only a single aspect thereof. For example, the analysis module 112 may analyze the natural language input 102 against a set of discrete criteria such as language that is positive, language that is actionable, and language that is subjective. Each of the analyses 114 may be performed on at least a portion of the natural language input 102. While three analyses 114 are illustrated in FIG. 1, any number of analyses may be carried out to determine if deficiencies are present in the natural language input 102, such as at least 1 analysis, 1 to 1,000,000 analyses, 3 to 100,000 analyses, 5 to 10,000 analyses, 100 to 1,000 analyses, less than 1,000,000 analyses, less than 100,000 analyses, less than 10,000 analyses, less than 1,000 analyses, less than 100 analyses, or more than 1,000 analyses. The number of discrete criteria addressed by the analyses 114 may be less than or equal to the number of analyses 114.

At block 120, any deficiencies in the natural language with respect to the discrete criteria are noted and can proceed to fetching dialogue corresponding to the one or more deficiencies associated with each analysis 114 at block 130. If there are no deficiencies in the natural language with respect to the discrete criteria, the algorithm 100 advanced to block 150 indicating that no message needs to be provided to the user or indicating to the user that the communication is ready for output to one or more recipients.

At block 130, the deficiencies indicated in the analyses 114 are received at the fetching module 132. The deficiencies indicated in the analyses 114 may be addressed by specific dialogue 134 corresponding thereto. The specific dialogue 134 may address each deficiency noted at block 110. For example, each deficiency noted by analyses 114 may have a corresponding dialogue 134. The dialogue 134 may include natural language outputs (e.g., textual statements and/or explanations). For example, the dialogue may include an invitation to correct a deficiency in the natural language input as indicated by a specific analysis. The dialogue may include a statement explaining the deficiency in the natural language input as indicated by a specific analysis. In some examples, the dialogue may include an explanation of the deficiency in the natural language. In some examples, the dialogue may include an explanation of considerations to contemplate when addressing the deficiency in the natural language. The dialogue may be communicated to the user as text.

At block 140, the recommended dialogue 134, if any, may be output to the user at the point of natural language input 102. If no dialogue is found, no message is provided to the user or a message recommending output of the natural language text may be provided to the user, at block 150.

According to the algorithm 100, immediate, specific, and customized coaching for effective communication in written electronic communication is implemented. In some embodiments, the coaching can be customized according to contextual inputs.

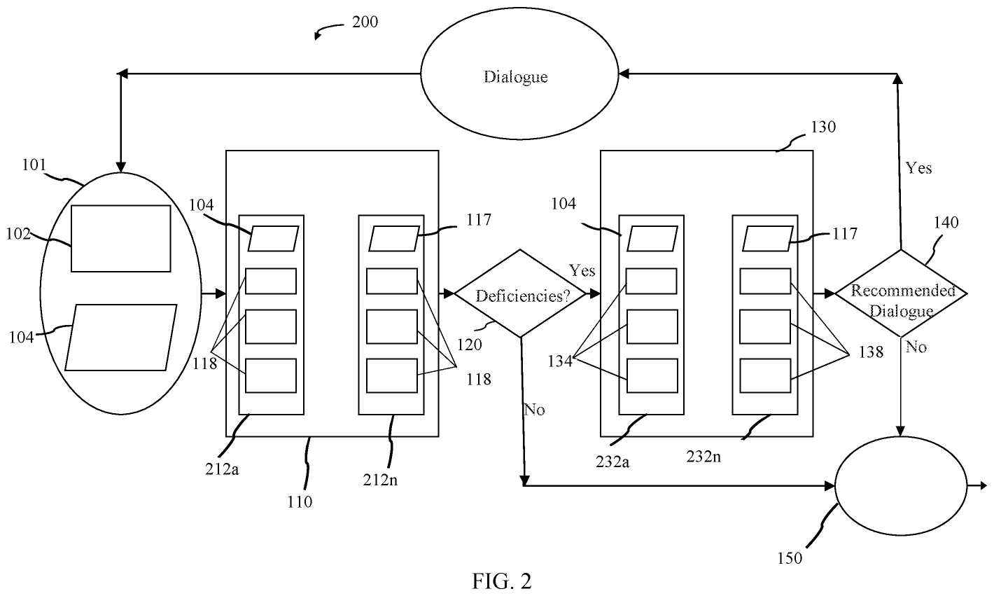

FIG. 2 is a block diagram of an algorithm 200 for automatically coaching a user's language used in electronic communications, according to an embodiment. The algorithm 200 may be similar or identical to the algorithm 100 in one or more aspects, such as including the analysis of natural language inputs at block 110 and retrieving dialogue corresponding to deficiencies detected in the natural language inputs at block 130, among others. The algorithm 200 describes a process for automatically providing customized, specific, immediate feedback for written communication provided as a natural language input with a contextual input. The contextual input filters the analyses and the dialogue output by the algorithm 200.

The algorithm 200 includes an input block 101 having a natural language input 102 and a contextual input 104, which is analyzed for deficiencies based on a plurality of criteria corresponding to the contextual input 104 at block 110. Based on determination that there are or are not deficiencies in the natural language at block 120, the algorithm 200 fetches context specific dialogue corresponding to the identified deficiencies and contextual input at block 130 or provides a message that the electronic communication is ready to output to a receiver at block 150. At block 130, the dialogue corresponding to the identified deficiencies and context is output. Based on the dialogue corresponding to the context and identified deficiencies in the natural language at block 140, the algorithm 100 outputs the recommended dialogue to the point of natural language input 102 or provides no message to the user at block 150.

The natural language input 102 is provided as disclosed above. Contemporaneously with the natural language input 102, the contextual input 104 is provided at block 101. The contextual input 104 may be provided in a fillable field, selected from a number of contextual inputs, or otherwise indicated by a user. Contextual inputs 104 may be include contextual information, such as sender and recipient relationship information (e.g., supervisor/supervisee, employer/employee, service provider/client, teacher/student, peer-to-peer, doctor/patient, etc.), situational information that describes the situation that the communication pertains to (e.g., professional work environment, evaluations, discipline, training, requests, work instructions, good news, bad news, etc.), desired outcomes, timelines for achieving the subject of the communication, or the like. The contextual inputs may be provided as text, which may be carried through the algorithm 200 to inform the analyses as block 110 and the retrieval of dialogue at block 130, as explained in more detail below. The contextual input 104 may be a preset setting in the communication platform, such that the contextual input 104 is automatically applied anytime a natural language input 102 is input into the communication platform.

The natural language input 102 is analyzed to determine if there are any deficiencies in the natural language in view of discrete criteria and the contextual input. At block 110 the natural language may be searched for specific words, terms, phrases, sentences, syntax, sentiment, or other elements as disclosed above. However, at block 110, the contextual input 104 may be referenced to determine which set of discrete criteria (as addressed by analyses 114 or 118) apply to the situation described by the contextual input 104. For example, a plurality of analysis modules 212a-212n may be provided at block 110, with each of the analysis modules 212a-212n applying to a different contextual input 104 or 117. As shown, the analysis module 212a may apply to contextual input 104 and analysis module 212n may apply to contextual input 117. In some examples, contextual input 104 may have overlapping applicability to any number of analysis modules and the associated contextual inputs therein. While shown as only having two analysis modules 212a and 212n, there may be any number of analysis modules at block 110, each applying to at least one specific contextual input.

At block 110, the contextual input 104 is referenced to determine which analysis module(s) 212a-212n apply to the natural language input analysis. By correlating the contextual input 104, with one or more corresponding analysis modules 212a-212n, the analysis is customized to the context in which the communication takes place. In such a manner, the analysis of the natural language input 102 is carried out in view of the context in which the natural language is provided. By filtering the analyses and dialogue by the context in which the communication is provided, the methods, systems, and products herein can increase computational speed of automatic language coaching systems and decrease the response time to the user to more effectively provide immediate, customized, and specific language coaching (for more effective communication).

The analysis modules 212a and 212n, may be similar or identical to the analysis module 112 in one or more aspects. Each of the analysis modules 212a and 212n may have a plurality of analyses therein. For example, analysis module 212a may include analyses 114 and analysis module 212n may include analyses 118. The analyses 114 and 118 may include any of the analyses disclosed herein with respect to FIG. 1, but specifically applied to a selected context. For example, the discrete criteria addressed by analyses 114 and 118 may include any of the discrete criteria disclosed herein.

In analysis module 212a or 212n within block 110, each discrete criteria may have a corresponding analysis 114 or 118, respectively. Each analysis 114 or 118 may examine only one specific discrete criteria or only a single aspect thereof, as applied to a selected context. For example, the analysis module 212a may analyze the natural language input 102 against a set of discrete criteria such as language that is positive, language that is actionable, and language that is subjective, in separate analyses 114. Likewise, the analysis module 212n may analyze the natural language input 102 against the same set of discrete criteria as analysis module 212a or a different set of discrete criteria, in analyses 118. Each of the analyses 114 or 118 may be performed on at least a portion of the natural language input 102. While three analyses 114 and 118 are illustrated in FIG. 2, any number of analyses 114 and/or 118 may be carried out to determine if deficiencies are present in the natural language input 102 as disclosed above. The number of discrete criteria addressed by the analyses 114 and 118 may be less than or equal to the number of analyses 114 and 118.

Deficiencies in the natural language, as disclosed herein, are used to fetch corresponding context specific dialogue. At block 120, any deficiencies in the natural language with respect to the discrete criteria and contextual input are noted and can proceed to fetching context specific dialogue corresponding to the one or more deficiencies associated with each analysis 114 and 118 at block 130. If there are no deficiencies in the natural language with respect to the discrete criteria, the algorithm 200 advances to block 150 indicating that no message needs to be provided to the user or indicating to the user that the communication is ready for output to one or more recipients.

At block 130, the deficiencies indicated in the analyses 114 and/or 118 are received at the fetching module 232a or 232n. The deficiencies indicated in the analyses 114 or 118 may be addressed by specific dialogue 134 or 138 corresponding thereto, respectively. Depending on the contextual input 104 or 117, at least one of the fetching modules 232a or 232n may be utilized. For example, contextual input 104 may trigger the use of fetching module 232a and contextual input 117 may trigger the use of fetching module 232n. Each fetching module 232a or 232n includes at least one piece of specific dialogue addressing one or more deficiencies in natural language as applied to a specific context. The specific dialogue 134 and 138 in the fetching modules 232a and 232n may address each deficiency noted at block 110. For example, each deficiency noted by analyses 114 may have a corresponding dialogue 134 and each deficiency noted by analyses 118 may have a corresponding dialogue 138. While two fetching modules are shown, any number of fetching modules may be utilized at block 130 and any number of specific dialogues 134 or 138 may be used in each.

The dialogue 134 or 138 may include natural language outputs (e.g., textual statements and/or explanations). For example, the dialogue may include one or more of an invitation to correct a deficiency in the natural language input as indicated by a specific analysis, a statement explaining the deficiency in the natural language input as indicated by a specific analysis, an explanation of the deficiency in the natural language, or an explanation of considerations to contemplate when addressing the deficiency in the natural language. The dialogue may be communicated to the user as text.

By correlating the analyses 114 or 118 and the contextual input 104 or 117, with one or more corresponding fetching modules 232a and 232n, the dialogue is customized to the context in which the communication takes place. In such a manner, the generation of dialogue relating to the deficiencies identified in the natural language input 102 is carried out in view of the context in which the natural language is provided. By filtering the dialogue by the context in which the communication is provided, the methods, systems, and products herein can increase computational speed of automatic language coaching systems and decrease the response time to the user to more effectively provide immediate, customized, and specific language coaching (for more effective communication).

At block 140, the recommended dialogue 134 or 138, if any, may be output to the user at the point of natural language input 102. If no dialogue is found, no message is provided to the user or a message recommending output of the natural language text may be provided to the user, at block 150.

One or more portions of the algorithm 100 or 200 may be implemented as software, hardware, firmware, or a cloud-based service as provided by a system (e.g., computer system, server(s), network, etc.). For example, the analysis engine and the dialogue engine may be implemented by a processor as portions of a computer readable and executable program (e.g., software).

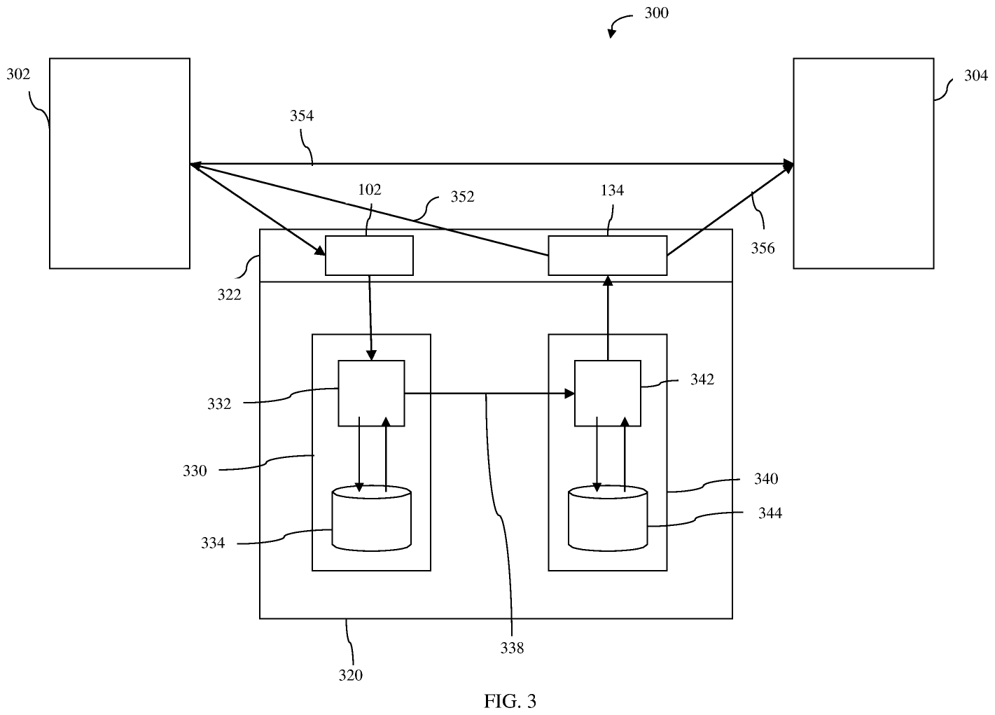

FIG. 3 is a block diagram of a system 300 for automatically coaching language used in electronic communications, according to an embodiment. The system 300 includes the computer program 320 having machine readable and executable instructions for automatically coaching interpersonal communications. The computer program 320 may be implemented as software applied in a computing device (e.g., server, computer, smartphone, tablet, etc.), computer network, or cloud network. For example, the computer program 320 may include a messaging platform such as e-mail software, a chat program, a chat bot, etc. or an add-on thereto.

The computer program 320 may be implemented by at least one computing device such as one or more of a server, a desktop computer, a laptop computer, a tablet, a smartphone, or the like. The computer program 320 may be stored in a memory storage of the at least one computing device and executed by a processor of the at least one computing device. The computer program 320 includes a user interface 322 (e.g., instructions for outputting an electronic communication portal) associated therewith, such as on the computing device, for display to a user. The computer program 320 includes instructions for analyzing natural language inputs 102 and providing dialogue to address deficiencies (according to discrete criteria) found in the natural language inputs 102 via the analyses. The sender 302 may view the user interface 322 at a first computing device and input the natural language input 102 into the user interface 322. As explained in more detail below the user interface 322 may provide fields for entering the natural language input and a contextual input, and fields for viewing the natural language input and dialogue provided from the computer program 320 for automatically coaching language used in electronic communications.

The natural language input 102 is provided to the analysis engine 330. The analysis engine 330 includes machine readable and executable instructions for analyzing the natural language input for deficiencies according to one or more discrete criteria. The analysis engine 330 may include one or more analyses 332 and at least one analysis database 334. The one or more analyses 332 may be similar or identical to the analyses 114 and 118 disclosed herein in one or more aspects. For example, each of the one or more analyses 332 (analysis 332) may analyze a different portion and/or aspect of the natural language input 102 for compliance with a specific discrete criteria associated with effective communication as disclosed herein with respect to analyses 114 and 118. In examples, the discrete criteria may include language that is positive, actionable, subjective, devoid of curt tone, devoid of irony, devoid of sarcasm, devoid of negativity, or the like. The one or more analyses 332 may be implemented as machine readable and executable queries of the analysis database 334 to compare a selected discrete criteria associated with effective communication to the natural language input 102.

The analysis database 334 includes one or more libraries of words, phrases, syntax structure(s), sentences, sentence structure(s), grammar rules, etiquette rules, or other data corresponding to elements known to provide effective communication (e.g., produce a desired outcome or understanding) or elements known to provide ineffective communication. The one or more libraries of words, phrases, syntax structure(s), sentences, sentence structure(s), grammar rules, etiquette rules, or other data corresponding to elements known to provide effective communication in the analysis database 334 may be populated with the above-noted elements by experts in language arts, psychology, interpersonal motivation, or the like. As such, the elements that are “known” to provide specific effect, be positive, be actionable, be negative, be curt, etc. may be “known” as such by inclusion in an electronic list or library of such elements by the expert(s).

In some examples, analysis 332 may query whether the natural language input contains words, terms, phrases, or sentences known to be positive. The analyses 332 may be stored in a library, database, or program code for execution by a processor. The analysis 332 can compare (e.g., via a processor of a computing device) the natural language input 102 with words, terms, phrases, or sentences in a library within the analysis database 334 known to be positive. If the natural language lacks such positive words, terms, phrases or sentences, the analysis engine 330 may output a corresponding indication. If the natural language includes such positive words, terms, phrases or sentences, the analysis engine 330 may provide no output based upon determined compliance with this discrete criteria or may output a corresponding indication that positive words, terms, phrase, or sentences are present. An additional analysis 332 can compare the natural language input with words, terms, phrases, or sentences in a library within the analysis database known to be actionable (e.g., inviting action). Similarly, the analysis engine 330 may output the results of the comparison. A further analysis 332 can compare the natural language input 102 with words, terms, phrases, or sentences in a library within the analysis database 334 known to be curt or sarcastic. If the natural language includes such curt or sarcastic words, terms, phrases or sentences, the analysis engine 330 may output a corresponding indication. If the natural language lacks such curt or sarcastic words, terms, phrases or sentences, the analysis engine 330 may provide no output based upon determined compliance these discrete criteria or may output a corresponding indication that curt or sarcastic words, terms, phrase, or sentences are not present. In some examples, analysis 332 may query whether the natural language input contains words, terms, phrases, sentences, or sentence structure indicating curtness. The analysis 332 can compare the natural language input 102 with words, terms, phrases, sentences or sentence structures in a library within the analysis database 334 containing curt words, terms, phrases, sentences, or sentence structures. Accordingly, the analysis engine 330 can be used to query the analysis database 334 for compliance with the discrete criteria.

The analyses 332 can be computer readable and executable instructions to interrogate (e.g., search, parse, query, or otherwise analyze) the natural language input for compliance with one or more discrete criteria. The analyses 332 can include any number of individual analyses, such as more than 1, 1 to 1,000,000, or less than 1,000,000 individual analyses.

In some examples (not shown), at least some of the one or more analysis 332 may be context dependent and only apply to certain contexts, when the context is provided by the user as a contextual input as disclosed herein. In such examples, the number of analyses may be reduced to only those applicable to the context of the electronic communication. In some examples, the natural language may be broken down into sentences, phrases, and words to analyze the sentences, phrases, and words against the plurality of discrete criteria in the one or more analyses 332.

The result of at least some of the one or more analyses, and optionally the natural language input 102 may be output (e.g., electronically communicated) to the dialogue engine 340 at output 338. For example, the results of the analyses 332 that indicate at least one of some type of deficiency in the natural language input 102 may be output to the dialogue engine 340. In some examples, the results of the analyses 332 that do not indicate a deficiency in the natural language input 102 may be output to the dialogue engine 340. In some examples, if no deficiencies are found, only a message that no deficiencies are present is output to the dialogue engine 340.

The dialogue engine 340 includes one or more fetch commands 342 corresponding to the output(s) of the analyses 332 and includes one or more dialogue databases 344. The dialogue engine 340 may be used to fetch dialogue corresponding to the results of the one or more analyses 332 for presentation to the sender 302. For example, one or more fetch commands 342 may be used to fetch dialogue corresponding to the results of the one or more analyses 332 from the dialogue database 344.

Fetch commands 342 may be stored in a library, database, or program code for execution by a processor. Each fetch command includes electronic instructions to fetch (e.g., electronically retrieve) dialogue corresponding to a specific result of a specific analysis 332. For example, fetch command 342 may include machine readable and executable instructions to retrieve dialogue indicating that a certain word, phrase, or sentence introduces a deficiency (e.g., negative words, lack of positive words, curt sentence, irony, etc.) into the natural language input 102. In some examples, the fetch command 342 may include instructions to fetch dialogue corresponding to the lack of deficiencies in the natural language input 102, such as a prompt to send the electronic communication or text explaining that no deficiencies were found. Accordingly, the fetch commands 342 retrieve dialogue to coach the sender 302 to improve their electronic communication, immediately, specifically, and according to the customized text of the electronic communication.

In some examples, specific fetch commands may only run in response to an indication that the result of a corresponding analysis 332 is present in output 338. For example, the fetch commands 342 may include macro program that identifies only those analyses 332 provided as output 338 that indicate deficiencies are present in the natural language input 102 and executes only the fetch commands 342 corresponding thereto.

The fetch commands 342 query the dialogue database 344 for dialogue corresponding to the result of a particular analysis 332, when the result of the analysis 332 has been output to the dialogue engine 340.

The dialogue database 344 includes one or more libraries of dialogue addressing deficiencies in at least one of the plurality of discrete criteria. Each piece of dialogue in the one or more libraries corresponds to the result of a particular analysis 332 (which each address at least one of the plurality of discrete criteria). For example, the libraries and/or the dialogue therein may be encoded with IDs corresponding to outputs of the analyses 332 or possible outputs of the analyses 332. The dialogue may include one or more of an explanation of the deficiency in the natural language, invitation to correct one or more deficiencies of at least one of the plurality of discrete criteria within the natural language, or an explanation of considerations to take into account when correcting the deficiency in the natural language.

In some examples (not shown), one or more libraries of dialogue in the dialogue database may be context specific. For example, one or more libraries of dialogue may correspond to a contextual input (104 or 117) provided with the natural language input 102. In such examples, the fetch commands 342 may query the libraries in the dialogue database 344 to determine which libraries correspond to the contextual input, thereby reducing the number of libraries searched for dialogue corresponding to the results of analyses 332 output from the analysis engine 330.

In some examples, the natural language input 102 and the analyses 332 for which deficiencies are indicated may be output to the dialogue engine 340. The contextual input may be output to the dialogue engine 340 with the natural language input 102 and the analyses 332. The dialogue engine 340 may also include instructions to highlight the text in the natural language for which the deficiencies. The dialogue engine 340 may also include instructions to visibly link the dialogue with the portion of the natural language input 102 that the dialogue addresses, such as via highlighting, coloring, brackets, a window, or the like. Accordingly, the sender 302 may have a visible cue as to which portion of the natural language input 102 to refer to when addressing the deficiencies indicated by the dialogue.

The dialogue is output from the dialogue engine 340 for display at the user interface 322. For example, the dialogue corresponding to the one or more analyses 332 may be published to the user interface 322 (e.g., of a communication platform or portal) for viewing and action by the sender 302 at point 352 before enabling or otherwise allowing the natural language inputs 102 to be sent to the recipient 304 in an electronic message at point 356. In some examples, outputting or publishing the dialogue corresponding to the one or more analyses to the communication portal before allowing the natural language inputs to be sent in the electronic message may include displaying a message within the user interface 322 (e.g., communication platform or portal) having an invitation to correct one or more deficiencies of at least one of the plurality of discrete criteria within the natural language. The message may contain the dialogue retrieved from the dialogue database 344 responsive to the indication(s) of deficiencies in the natural language input 102 as determined by the analyses 332. After the sender 302 addresses the deficiencies, the revised natural language input may be sent through the computer program 320 again for further refinement (e.g., analysis and revisions based thereon) or may be sent directly to the recipient 304 at point 354 or 356. For example, the sender 302 may enter the natural language input 102 into a communication platform (e.g., messaging program) at a first computing device, where the communication platform includes an add-on containing the computer program 320. Accordingly, upon determining that the natural language input 102 does not contain any deficiencies, the sender 302 may send the electronic communication containing the natural language input 102 through the communication platform directly to the recipient as shown at point 354. In some examples, the natural language input 102, whether revised to satisfy the discrete criteria or not, may be sent to the recipient 304 through the computer program 320. For example, the computer program 320 may be a part of the communication platform (e.g., communication portal). Accordingly, the user interface 322 may be used to send the electronic message to the recipient 304 at a second computing device as shown at point 356. In some examples, both the sender 302 and the recipient 304 may have access to the computer program 320, such as both being able to see the user interface 322 when sending electronic communications. In some examples, only the sender 302 has access to the computer program 320.

In some examples, the computer program 320 may be implemented as software on one or more of the sender's computing device, the recipient's computing device, a web-based application stored on a messaging service provider's server(s), a cloud-based computing program, or the like.

While not shown in FIG. 3, the user interface 322 may also receive contextual inputs and the analysis engine 330 and dialogue engine 340 may utilize the contextual inputs as disclosed herein with respect to the algorithm 200.

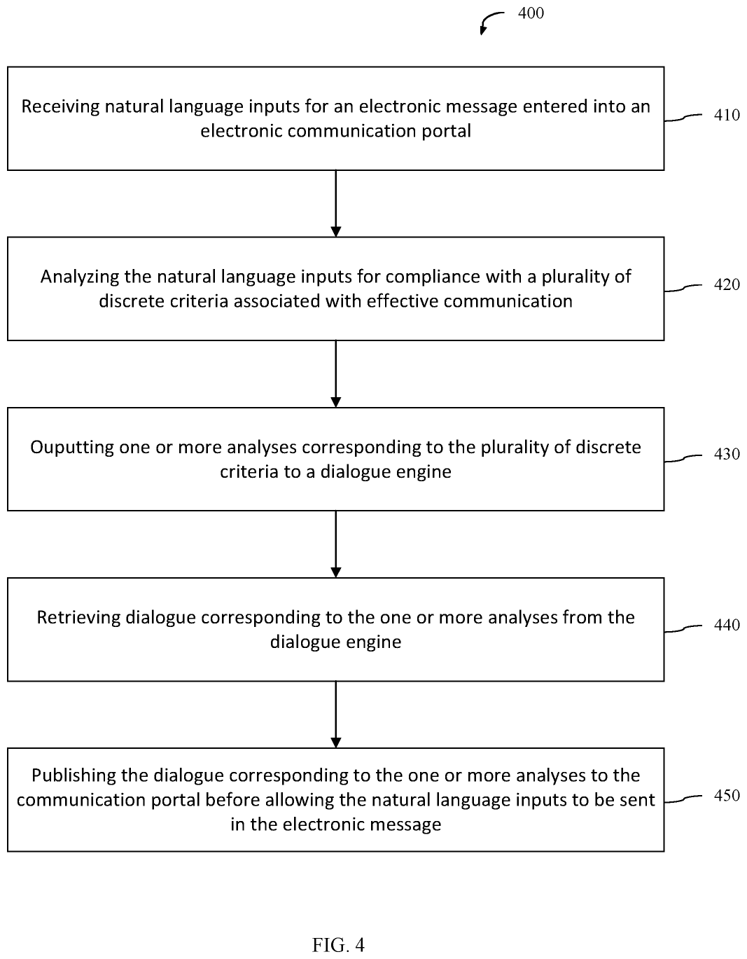

FIG. 4 is a flow diagram of a method 400 of automatically coaching language used in electronic communications, according to an embodiment. The method 400 includes an act 410 of receiving natural language inputs for an electronic message entered into an electronic communication portal; an act 420 of analyzing the natural language inputs or compliance with a plurality of discrete criteria associated with effective communication; an act 430 of outputting one or more analyses corresponding to the plurality of discrete criteria to a dialogue engine; an act 440 of retrieving dialogue corresponding to the one or more analyses from the dialogue engine; and an act 450 of publishing the dialogue corresponding to the one or more analyses to the communication portal before allowing the natural language inputs to be sent in the electronic message. At least some of the acts 410-450 may be performed in a different order than presented, may be omitted, or may have additional acts performed therebetween. For example, act 410 may be omitted and the natural language input may be provided in another way such as directly into a computer program for coaching language.

The act 410 of receiving natural language inputs for an electronic message entered into an electronic communication portal may include receiving electronic messages typed into the electronic communication portal or platform, such as e-mail software, messaging software, chat software, or the like. For example, receiving natural language inputs for an electronic message entered into an electronic communication portal may include receiving a message typed into a chat software application. The natural language inputs may be provided by a sender of a message by typing, voice command, or otherwise entering natural language as text into a fillable field, such as message window in the electronic communication platform.

The act 420 of analyzing the natural language inputs for compliance with a plurality of discrete criteria associated with effective communication may include performing any of the analyses disclosed herein on the natural language input. For example, the analyses can interrogate whether the natural language inputs comply with a plurality of discrete criteria, such as any of the discrete criteria disclosed herein. In some examples, the plurality of discrete criteria include language that is positive, actionable, subjective, devoid of irony, devoid of sarcasm, devoid of curtness, etc. according to reference words, terms, phrases, sentences, grammar rules, or other elements grouped into categories defining the plurality of discrete criteria. The categories may be located in a database within an analysis engine, such as in one or more libraries therein.

In examples, analyzing the natural language inputs for compliance with a plurality of discrete criteria associated with effective communication may include searching the natural language inputs for reference words, terms, phrases, sentences, sentence structures, syntax, grammar, sentiment or other elements grouped into at least one of the plurality of discrete criteria in a database within an analysis engine. For example, reference words associated with one or more discrete criteria of effective communication may be grouped into libraries stored in an analysis database as disclosed herein. Searching the natural language inputs for elements (e.g., reference words or phrases) grouped into at least one of the plurality of discrete criteria in a database within an analysis engine may include determining if the reference words or phrases indicate a deficiency related to the at least one of the plurality of discrete criteria. For example, the deficiency related to the at least one of the plurality of discrete criteria may include an absence of natural language inputs addressing at least one of the plurality of discrete criteria. In examples, analyzing the natural language inputs for compliance with a plurality of discrete criteria associated with effective communication includes determining if there is an absence of elements (e.g., reference words or phrases) corresponding to each of the plurality of discrete criteria. For example, analyzing the natural language inputs for compliance with a plurality of discrete criteria associated with effective communication includes determining if words, terms, phrases, sentences, grammar, or other elements in the natural language inputs are positive, actionable, subjective, curt, ironic, sarcastic, include an anti-productive sentiment, or the like. Determining if the reference words or phrases in the natural language inputs are positive, actionable, and subjective may include (electronically) comparing the natural language inputs to one or more databases of words or phrases known to be positive, words or phrases known to be negative, words or phrases known to be actionable, words or phrases known to be subjective, words or phrases known to be curt, or words or phrases indicating irony, within the a database in the analysis engine. The analysis can compare the natural language input to the libraries to determine if such reference words are or are not in the natural language input. Addressing the absence of such elements can provide effective communication.

In examples, analyzing the natural language inputs for compliance with a plurality of discrete criteria associated with effective communication may include searching the natural language inputs for reference words, terms, phrases, sentences, sentence structures, syntax, grammar, or other elements associated with one or more discrete criteria of ineffective communication in a database within an analysis engine. For example, one or more deficiencies related to the at least one of the plurality of discrete criteria may include words, terms, phrases, sentences or the like having a negative connotation in the natural language inputs. The reference words, terms, phrases, sentences, sentence structures, syntax, grammar, or other elements associated with one or more discrete criteria of ineffective communication may be grouped into libraries stored in the analysis database as disclosed herein. In such examples, the analyses may determine if such reference words, terms, phrases, sentences, sentence structures, syntax, grammar, or other elements are present to provide an indication that replacement of such elements are necessary for effective communication. Replacement of such elements can provide effective communication.

The analysis may be initiated by an analysis command in the dialogue engine, such as responsive to receiving the natural language inputs. An analysis command may be executed for each discrete criteria and/or portion of the natural language input. As noted above, analyses corresponding to each discrete criteria may be stored in the analysis engine, such as in database, for execution by the analysis engine.

The act 430 of outputting one or more analyses corresponding to the plurality of discrete criteria to a dialogue engine may include electronically communicating the one or more analyses that indicate that a deficiency is present in the natural language inputs to the dialogue engine. In some examples, outputting one or more analyses corresponding to the plurality of discrete criteria to a dialogue engine may include outputting an indication of one or more deficiencies within the natural language inputs corresponding to the at least one of the plurality of discrete criteria. Such examples may include outputting an indication of a deficiency only for each analysis or discrete criteria for which a deficiency is found. In some examples, outputting one or more analyses corresponding to the plurality of discrete criteria to a dialogue engine includes outputting an indication of one or more deficiencies within the natural language inputs corresponding to portions of natural language inputs that are one or more of positive, actionable, or subjective, curt, ironic, sarcastic, express objectionable sentiment, have grammatical errors or other deficiencies.

In some examples, the method 400 may include outputting the portions of the natural language inputs that correspond to the deficiencies determined by the analyses, such as one or more of not positive, not actionable, not subjective, curt, ironic, sarcastic, or the like. In some examples, the method 400 may include outputting the portions of the natural language inputs that correspond to the language therein that is positive, actionable, subjective, not curt, not ironic, not sarcastic, or the like. Such portions of the natural language inputs may be output with the results of the analyses.

The act 440 of retrieving dialogue corresponding to the one or more analyses from the dialogue engine may include retrieving any of the dialogue disclosed herein. Retrieving dialogue corresponding to the one or more analyses from the dialogue engine may include retrieving dialogue from a database of dialogue addressing deficiencies in at least one of the plurality of discrete criteria as disclosed herein. Retrieving dialogue corresponding to the one or more analyses from the dialogue engine may include retrieving dialogue corresponding to the one or more analyses output from the analysis engine that indicate a deficiency is present.

In some examples, retrieving dialogue corresponding to the one or more analyses from the dialogue engine may include retrieving dialogue having an invitation to correct one or more deficiencies of at least one of the plurality of discrete criteria within the natural language inputs. The invitation to correct the deficiency may be an invitation to provide natural language inputs that provide elements (e.g., actionable words, positive words, etc.) that are missing from the natural language inputs or to remove elements from the natural language inputs that are associated with ineffective communication (e.g., negative words, sarcasm, irony, etc.). For example, the invitation to correct one or more deficiencies of at least one of the plurality of discrete criteria within the natural language inputs may include providing an indication of the natural language inputs corresponding to a specific deficiency, such as highlighting, color coding, bracketing or otherwise indicating a selected portion of the natural language input associated with the dialogue corresponding to a deficiency determined by the analyses.

Retrieving dialogue corresponding to the one or more analyses from the dialogue engine may include retrieving dialogue stating that no deficiencies are present. Retrieving dialogue corresponding to the one or more analyses from the dialogue engine may include retrieving dialogue inviting the sender to send the message to a recipient. The dialogue corresponding to the one or more analyses may include a prompt requiring an action before the electronic message (containing the revised natural language input) can be sent.

The retrieval may be initiated by a retrieval command in the dialogue engine, such as responsive to receiving the analyses from the analysis engine. A retrieval command may be executed for each analysis that indicates a deficiency is present. As noted above, dialogue corresponding to each analysis may be stored in the dialogue database for retrieval (e.g., fetching) by the dialogue engine.

The act 450 of publishing the dialogue corresponding to the one or more analyses to the communication portal before allowing the natural language inputs to be sent in the electronic message. Publishing the dialogue corresponding to the one or more analyses to the communication portal may include executing machine readable instructions to display the dialogue on the user interface such as in the communication portal (e.g., messaging software) displayed on the user interface, such as via the processor of a computing device. Publishing the dialogue corresponding to the one or more analyses to the communication portal before allowing the natural language inputs to be sent in the electronic message may include displaying the dialogue in the communication portal in natural language text format. For example, publishing the dialogue corresponding to the one or more analyses to the communication portal before allowing the natural language inputs to be sent in the electronic message may include displaying a message within the communication portal having an invitation to correct one or more deficiencies of at least one of the plurality of discrete criteria within the natural language inputs, such as inserted into, inserted adjacent to, or overlaid on the text of the natural language inputs. The invitation to correct one or more deficiencies of at least one of the plurality of discrete criteria within the natural language inputs may include providing an indication of the natural language inputs corresponding to a specific deficiency.

Publishing the dialogue corresponding to the one or more analyses to the communication portal before allowing the natural language inputs to be sent in the electronic message may include displaying comments regarding each of the deficiencies found in the analyses. The plurality of comments may include comments (e.g., invitations to correct or statements of the deficiency) for different aspects of a single discrete criteria or a plurality of discrete criteria. The display may be shown in the user interface of a computing device of the sender of natural language input (e.g., electronic message).

In some examples, the acts 410-450 may be repeated more than once to iteratively refine the natural language input prior to sending the electronic communication to a recipient.

In some examples, the method 400 may include receiving a contextual input, such as any of the contextual inputs disclosed herein. In such examples, the analyses and dialogue retrieval may be carried out in view of the contextual input as disclosed herein. In such examples, the computational speed of the acts for automatically coaching language is increased and response time is decreased by filtering analysis and dialogue by contextual inputs.

While disclosed herein with respect to written communication, in some examples, the algorithms, methods, systems, and products disclosed herein may be used with audio messages embodied in electronic media, where the audio messages are first converted to text format and then treated as disclosed herein with respect to written communications.

Each of the acts of the method 400 disclosed herein may be performed by a computing device (e.g., personal computer, laptop computer, server, tablet, smart phone, or the like), cloud computing device(s), or the like according to a computer program (e.g., software, application software, or the like) stored thereon. One or more of the acts of described herein with respect to the method 400, the algorithm 100 or 200, or the system 300 may be carried out by a processor of a computing device. One or more aspects of the method 400 may be carried out according to any of the algorithms 100 or 200 disclosed herein. One or more aspects of the method 400 may be carried out as disclosed with respect to the system 300.

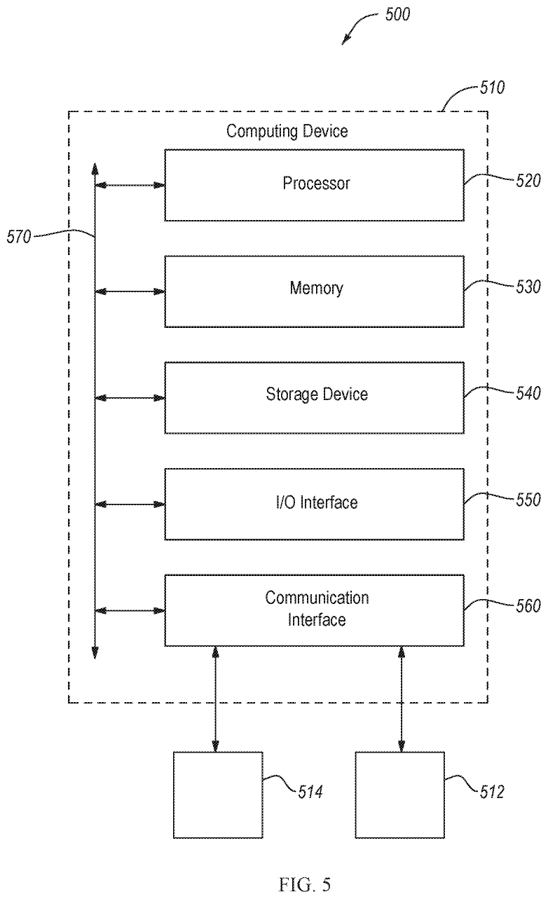

Any of the example systems disclosed herein may be used to carry out any of the example methods disclosed herein, such as using a controller. FIG. 5 is a schematic of a controller 500 for executing any of the example methods disclosed herein, according to an embodiment. The controller 500 may be configured to implement any of the example methods disclosed herein, such as the method 400, for performing the algorithms 100 and 200, or any of the acts of the system 300. The controller 500 includes at least one computing device 510. The at least one computing device 510 is an exemplary computing device that may be configured to perform one or more of the acts described above, such as the method 400, for performing the algorithms 100 and 200, or any of the acts of the system 300. The at least one computing device 510 can include one or more servers, one or more computers (e.g., desktop computer, laptop computer), or one or more mobile computing devices (e.g., smartphone, tablet, etc.). The computing device 510 can comprise at least one processor 520, memory 530, a storage device 540, an input/output (“I/O”) device/interface 550, and a communication interface 560. While an example computing device 510 is shown in FIG. 5, the components illustrated in FIG. 5 are not intended to be limiting of the controller 500 or computing device 510. Additional or alternative components may be used in some examples. Further, in some examples, the controller 500 or the computing device 510 can include fewer components than those shown in FIG. 5. For example, the controller 500 may not include the one or more additional computing devices 512 or 514. In some examples, the at least one computing device 510 may include a plurality of computing devices, such as a server farm, computational network, a cloud network, or cluster of computing devices. Components of computing device 510 shown in FIG. 5 are described in additional detail below.

In some examples, the processor(s) 520 includes hardware for executing instructions (e.g., instructions for carrying out one or more portions of any of the methods disclosed herein), such as those making up a computer program. For example, to execute instructions, the processor(s) 520 may retrieve (or fetch) the instructions from an internal register, an internal cache, the memory 530, or a storage device 540 and decode and execute them. In particular examples, processor(s) 520 may include one or more internal caches for data such as databases or libraries. As an example, the processor(s) 520 may include one or more instruction caches, one or more data caches, and one or more translation lookaside buffers (TLBs). Instructions in the instruction caches may be copies of instructions in memory 530 or storage device 540. In some examples, the processor 520 may be configured (e.g., include programming stored thereon or executed thereby) to carry out one or more portions of any of the example methods disclosed herein.

In some examples, the processor 520 is equipped or programmed to perform any of the acts disclosed herein such as in method 400, the algorithms 100 and 200, or the acts performed by the system 300, or cause one or more portions of the computing device 510 or controller 500 to perform at least one of the acts disclosed herein. Such configuration can include one or more operational programs (e.g., computer program products) that are executable by the at least one processor 520. For example, the processor 520 may be configured to automatically receive natural language inputs for an electronic message, analyze the natural language inputs for compliance with a plurality of discrete criteria associated with effective communication, output one or more analyses corresponding to the plurality of discrete criteria to a dialogue engine, retrieve dialogue corresponding to the one or more analyses from the dialogue engine; and publishing the dialogue corresponding to the one or more analyses to the communication portal before allowing the natural language inputs to be sent in the electronic message.

The at least one computing device 510 (e.g., a server) may include at least one memory storage medium (e.g., memory 530 and/or storage device 540). The computing device 510 may include memory 530, which is operably coupled to the processor(s) 520. The memory 530 may be used for storing data, metadata, and programs for execution by the processor(s) 520. The memory 530 may include one or more of volatile and non-volatile memories, such as Random Access Memory (RAM), Read Only Memory (ROM), a solid state disk (SSD), Flash, Phase Change Memory (PCM), or other types of data storage. The memory 530 may be internal or distributed memory.

The computing device 510 may include the storage device 540 having storage for storing data or instructions. The storage device 540 may be operably coupled to the at least one processor 520. In some examples, the storage device 540 can comprise a non-transitory memory storage medium, such as any of those described above. The storage device 540 (e.g., non-transitory storage medium) may include a hard disk drive (HDD), a floppy disk drive, flash memory, an optical disc, a magneto-optical disc, magnetic tape, or a Universal Serial Bus (USB) drive or a combination of two or more of these. Storage device 540 may include removable or non-removable (or fixed) media. Storage device 540 may be internal or external to the computing device 510. In some examples, storage device 540 may include non-volatile, solid-state memory. In some examples, storage device 540 may include read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these. In some examples, one or more portions of the memory 530 and/or storage device 540 (e.g., memory storage medium(s)) may store one or more databases thereon. At least some of the databases may be used to store one or more analyses, pieces of dialogue, discrete criteria, or the like, as disclosed herein. At least some of the databases may include libraries of data therein, such as any of the libraries disclosed herein.

In some examples, one or more analysis databases, dialogue databases, libraries, discrete criteria, analyses, instructions for performing any of the acts disclosed herein, instructions for performing any of the algorithms disclosed herein, or instructions of any of the computer programs disclosed herein may be stored in a memory storage medium such as one or more of the at least one processor 520 (e.g., internal cache of the processor), memory 530, or the storage device 540. In some examples, the at least one processor 520 may be configured to access (e.g., via bus 570) the memory storage medium(s) such as one or more of the memory 530 or the storage device 540. For example, the at least one processor 520 may receive and store the data (e.g., look-up tables) as a plurality of data points in the memory storage medium(s). The at least one processor 520 may execute programming stored therein adapted access the data in the memory storage medium(s) to automatically receive natural language inputs for an electronic message, analyze the natural language inputs for compliance with a plurality of discrete criteria associated with effective communication, output one or more analyses corresponding to the plurality of discrete criteria to a dialogue engine, retrieve dialogue corresponding to the one or more analyses from the dialogue engine; and publishing the dialogue corresponding to the one or more analyses to the communication portal before allowing the natural language inputs to be sent in the electronic message. For example, the at least one processor 520 may access one or more analysis or dialogue databases or libraries therein in the memory storage medium(s) such as memory 530 or storage device 540.

The computing device 510 also includes one or more I/O devices/interfaces 550, which are provided to allow a user to provide input to, receive output from, and otherwise transfer data to and from the computing device 510. These I/O devices/interfaces 550 may include a mouse, keypad or a keyboard, a touch screen, camera, optical scanner, network interface, web-based access, modem, a port, other known I/O devices or a combination of such I/O devices/interfaces 550. The touch screen may be activated with a stylus or a finger.

The I/O devices/interfaces 550 may include one or more devices for presenting output to a user, including, but not limited to, a graphics engine, a display (e.g., a display screen or monitor), one or more output drivers (e.g., display drivers), one or more audio speakers, and one or more audio drivers. In certain examples, I/O devices/interfaces 550 are configured to provide graphical data to a display for presentation to a user, such as on a user interface. The graphical data may be representative of one or more graphical user interfaces and/or any other graphical content as may serve a particular implementation.

The computing device 510 can further include a communication interface 560. The communication interface 560 can include hardware, software, or both. The communication interface 560 can provide one or more interfaces for communication (such as, for example, packet-based communication) between the computing device 510 and one or more additional computing devices 512 and 514 or one or more networks. For example, communication interface 560 may include a network interface controller (NIC) or network adapter for communicating with an Ethernet or other wire-based network or a wireless NIC (WNIC) or wireless adapter for communicating with a wireless network, such as a WI-FI.

Any suitable network and any suitable communication interface 560 may be used. For example, computing device 510 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, one or more portions of controller 500 or computing device 510 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof. Computing device 510 may include any suitable communication interface 560 for any of these networks, where appropriate.

The computing device 510 may include a bus 570. The bus 570 can include hardware, software, or both that couples components of computing device 510 to each other. For example, bus 570 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

The additional computing devices 512 and 514 may include programming thereon to communicate with the computing device 510. The additional computing devices 512 and 514 may be similar or identical to the computing device 510 in one or more aspects. In some examples, the computing device may be a server, the additional computing device 512 may be the computing device of a sender of an electronic communication, and the additional computing device 514 may be the computing device of a recipient of the electronic communication. The instructions for carrying out the methods disclosed herein (including the algorithms 100 and 200 as well as the acts performed by the system 300) may be stored on and carried out by the computing device 510. In some examples, the computing device 510 is a personal computing device of the sender and the computing device 514 is the computing device of the recipient. In such examples, the instructions for carrying out the methods disclosed herein may be stored on and executed by the computing device 510. It should be appreciated that any of the examples of acts described herein, such as in the algorithms 100 and 200, the system 300, or method 400 may be performed by and/or at one or more of the computing device 510, the additional computing device 512, or the computing device 514.

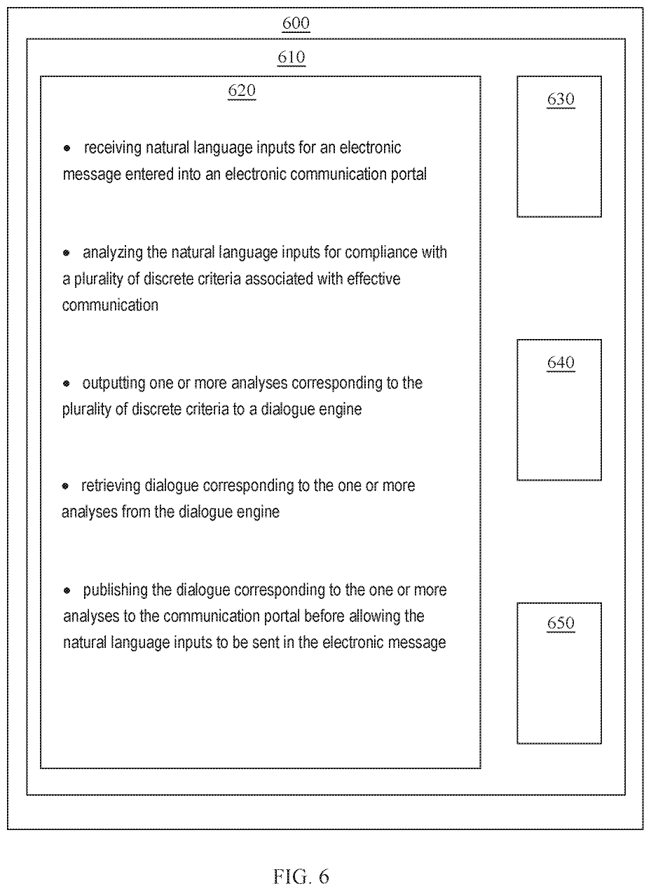

FIG. 6 is a block diagram illustrating an example computer program product 600 that is arranged to store instructions for automatically coaching language used in electronic communications as disclosed herein. The signal bearing medium 602 (non-transitory memory storage medium) which may be implemented as or include a computer-readable medium 606, a computer recordable medium 608, a computer communications medium 610, or combinations thereof, stores machine readable and executable instructions 604 that may configure an associated processing unit to perform all or some of the techniques (e.g., acts) disclosed herein. The instructions may include instructions for carrying out any of the method 400, the algorithms 100 and 200, or the acts of the system 300 as disclosed herein. Such instructions may include, one or more machine readable and executable instructions for receiving natural language inputs for an electronic message entered into an electronic communication portal; analyzing the natural language inputs for compliance with a plurality of discrete criteria associated with effective communication; outputting one or more analyses corresponding to the plurality of discrete criteria to a dialogue engine; retrieving dialogue corresponding to the one or more analyses from the dialogue engine; and publishing the dialogue corresponding to the one or more analyses to the communication portal before allowing the natural language inputs to be sent in the electronic message. The dialogue corresponding to the one or more analyses may include a prompt requiring an action before the electronic message can be sent.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

What is claimed is:

1. A method of automatically coaching language used in electronic communications, the method comprising:
receiving natural language inputs for an electronic message entered into an electronic communication portal;
analyzing the natural language inputs for compliance with a plurality of discrete criteria associated with effective communication;
outputting one or more analyses corresponding to the plurality of discrete criteria to a dialogue engine;
retrieving dialogue corresponding to the one or more analyses from the dialogue engine; and
publishing the dialogue corresponding to the one or more analyses to the communication portal before allowing the natural language inputs to be sent in the electronic message.

2. The method of claim 1, wherein receiving natural language inputs for an electronic message entered into an electronic communication portal includes receiving a message typed into a chat software application.

3. The method of claim 1, wherein the plurality of discrete criteria include language that is positive, actionable, and subjective according to reference words or phrases grouped into categories defining the plurality of discrete criteria in a database within an analysis engine.

4. The method of claim 1, wherein analyzing the natural language inputs for compliance with a plurality of discrete criteria associated with effective communication includes searching the natural language inputs for reference words or phrases grouped into at least one of the plurality of discrete criteria in a database within an analysis engine.

5. The method of claim 4, wherein analyzing the natural language inputs for compliance with a plurality of discrete criteria associated with effective communication includes determining if there is an absence of reference words or phrases corresponding to each of the plurality of discrete criteria.

6. The method of claim 4, wherein analyzing the natural language inputs for compliance with a plurality of discrete criteria associated with effective communication includes determining if the reference words or phrases in the natural language inputs are positive, actionable, and subjective.

7. The method of claim 6, wherein determining if the reference words or phrases in the natural language inputs are positive, actionable, and subjective includes comparing the natural language inputs to one or more database of words or phrases known to be positive, words or phrases known to be negative, words or phrases known to be actionable, words or phrases known to be subjective, words or phrases known to be curt, or words or phrases indicating irony, within the analysis engine.

8. The method of claim 4, wherein searching the natural language inputs for reference words or phrases grouped into at least one of the plurality of discrete criteria in a database within an analysis engine includes determining if the reference words or phrases indicate a deficiency related to the at least one of the plurality of discrete criteria.

9. The method of claim 8, wherein the deficiency related to the at least one of the plurality of discrete criteria includes an absence of natural language inputs addressing at least one of the plurality of discrete criteria.

10. The method of claim 8, wherein the deficiency related to the at least one of the plurality of discrete criteria includes words or phrases having a negative connotation in the natural language inputs.

11. The method of claim 1, wherein outputting one or more analyses corresponding to the plurality of discrete criteria to a dialogue engine includes outputting an indication of one or more deficiencies within the natural language inputs corresponding to the at least one of the plurality of discrete criteria.

12. The method of claim 1, wherein outputting one or more analyses corresponding to the plurality of discrete criteria to a dialogue engine includes outputting an indication of one or more deficiencies within the natural language inputs corresponding to portions of natural language inputs that are one or more of positive, actionable, or subjective.

13. The method of claim 12, further comprising outputting the portions of natural language inputs that are one or more of positive, actionable, or subjective.

14. The method of claim 1, wherein retrieving dialogue corresponding to the one or more analyses from the dialogue engine includes retrieving dialogue having an invitation to correct one or more deficiencies of at least one of the plurality of discrete criteria within the natural language inputs.

15. The method of claim 1, wherein retrieving dialogue corresponding to the one or more analyses from the dialogue engine includes retrieving dialogue from a database of dialogue addressing deficiencies in at least one of the plurality of discrete criteria.

16. The method of claim 1, wherein publishing the dialogue corresponding to the one or more analyses to the communication portal before allowing the natural language inputs to be sent in the electronic message includes displaying a message within the communication portal having an invitation to correct one or more deficiencies of at least one of the plurality of discrete criteria within the natural language inputs.

17. The method of claim 16, wherein the invitation to correct one or more deficiencies of at least one of the plurality of discrete criteria within the natural language inputs includes providing an indication of the natural language inputs corresponding to a specific deficiency.

18. The method of claim 1, wherein each of receiving natural language inputs for an electronic message entered into an electronic communication portal, analyzing the natural language inputs for compliance with a plurality of discrete criteria associated with effective communication, outputting one or more analyses corresponding to the plurality of discrete criteria to a dialogue engine, retrieving dialogue corresponding to the one or more analyses from the dialogue engine, and publishing the dialogue corresponding to the one or more analyses to the communication portal before allowing the natural language inputs to be sent in the electronic message, are performed by a computing device.

19. A computer program product for automatically coaching interpersonal communication, the computer program product including:
a non-transitory memory storage medium storing computer readable and executable instructions for:
receiving natural language inputs for an electronic message entered into an electronic communication portal;
analyzing the natural language inputs for compliance with one or more discrete criteria associated with effective communication;
outputting one or more analyses corresponding to the one or more discrete criteria to a dialogue engine;
retrieving dialogue corresponding to the one or more analyses from the dialogue engine; and
publishing the dialogue corresponding to the one or more analyses to the communication portal before allowing the natural language inputs to be sent in the electronic message.

20. The computer program product of claim 19, wherein the dialogue corresponding to the one or more analyses includes a prompt requiring an action before the electronic message can be sent.

21. A computing device for automatically coaching interpersonal communication, the computing device including:
a non-transitory memory storage medium storing machine readable and executable instructions for:
receiving natural language inputs for an electronic message entered into an electronic communication portal;
analyzing the natural language inputs for compliance with one or more discrete criteria associated with effective communication;
outputting one or more analysis corresponding to the one or more discrete criteria to a dialogue engine;
retrieving dialogue corresponding to the one or more analyses from the dialogue engine; and
publishing the dialogue corresponding to the one or more analyses to the communication portal before allowing the natural language inputs to be sent in the electronic message; and
a processor configured to access and execute the machine readable and executable instructions.

22. The computing device of claim 21, wherein the non-transitory memory storage medium and the processor are housed in a desktop computer, a laptop computer, a server, a tablet device, or a cellular telephone.
